(19) United States
(12) Patent Application Publication
(10) Pub. No.: US 2025/0008294 A1
(43) Pub. Date: Jan. 2, 2025

(54) User Attentiveness Indicator

(71) Applicant: Nokia Technologies Oy, Espoo (FI)

(72) Inventors: Miikka Tapani VILERMO, Siuro (FI); Koray OZCAN, Farnborough (GB)

(21) Appl. No.: 18/754,331

(22) Filed: Jun. 26, 2024

(30) Foreign Application Priority Data
Jun. 30, 2023 (GB) 2310049.8

(51) Int. Cl. H04S 7/00

(52) U.S. Cl. CPC H04S 7/40

(57) ABSTRACT

A method for visualizing sound audibility of external audio signals, the method including: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

### FIELD

The present application relates to apparatus and methods for indicating user attentiveness.

### BACKGROUND

User attentiveness is often not easy to determine. There are many situations in which it can be difficult to determine when another person operating an apparatus can hear someone attempting to attract their attention.

For example immersive communications and audio scenarios can significantly take the interest of the user of a mobile handset implementing an Immersive Voice and Audio Services (IVAS) audio codec can become almost totally immersed in the audio scene being rendered to the user. Even where the apparatus, such as a mobile handset with microphones configured to pass to audio signals which are passed to the user then the user's cognitive abilities can be immersed in the communication and not ‘hear’ the local talker.

Similarly where the apparatus is a vehicle within which the user is located, the quality of the noise cancelling and noise blocking, which is implemented as part of a vehicle noise vibration and sound quality design can acoustically isolate the user or passenger of the vehicle significantly and prevent someone outside the vehicle communicating with the driver or passenger.

Furthermore many motorcyclists wear noise cancelling or noise blocking apparatus within their helmets in order to attempt to reduce hearing damage caused by wind noise created by the helmet. However these noise cancelling or noise blocking apparatus can cause problems in that someone attracting the attention of the motorcyclist may not be able to attract the attention of the rider.

Also it is known that headphones equipped with ANC (Active Noise Cancellation) and pass-through/transparency features are becoming more common. ANC actively (using electronics, microphones and speaker elements) attenuates sounds from external sound sources for the headphone user. A pass through/transparency mode in turn actively plays back external sound sources to the user wearing headphones so that the user can hear their surroundings like cars and hear and talk to other people present in the same space. Ideally, in transparency mode the user would hear their surroundings as if they were not wearing headphones.

Many headphones allow a user to select how much they hear external sounds and thus the device can gradually alternate between ANC and transparency modes.

Headphone users can also control how loud headphones play music and other internal sounds from devices that are connected to the headphones. “Internal sounds” in the following is used to cover all internal sound sources such as the device playing music, telecommunications, UI sounds, any application sounds etc. In the following examples the example “internal sounds” is a music source but can be any other suitable source.

Headphone users can typically hear external sounds from two different routes. Firstly, a transparency mode can be configured to actively play back external sounds and secondly, external sounds can leak acoustically through and around the headphones into a user's ears. In the following disclosure pure acoustical leakage is referred to as acoustical leakage and the combination of acoustical leakage and transparency mode is referred as leakage.

### SUMMARY

There is provided according to a first aspect a method for visualizing sound audibility of external audio signals, the method comprising: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

Obtaining at least one external audio signal may comprise obtaining at least one external microphone audio signal, wherein the at least one external microphone is located on or acoustically coupled to an exterior surface of an apparatus, such that the at least one external microphone audio signal is configured to capture audio external to the apparatus.

Obtaining at least one internal audio signal may comprise obtaining at least one internal microphone audio signal, wherein the at least one internal microphone is located on or acoustically coupled to an interior surface of an apparatus, such that the at least one internal microphone audio signal is configured to capture audio internal to the apparatus.

Obtaining an estimate of at least one internal audio signal may comprise estimating at least one internal audio signal to be output via a transducer within the apparatus, such that the estimate of the at least one internal audio signal is configured to assist in estimating the external sound audibility.

Estimating an external sound audibility based at least partially on the at least one external audio signal and at least one of: the internal audio signal; and the estimate an at least one internal audio signal may comprise: determining an acoustic leakage estimate based on the at least one external audio signal and a function defining the relationship between the at least one external signal to an effective listening signal for a user; generating an anti-noise audio signal based on the at least one external audio signal; and generating the at least one external sound audibility based on subtracting the anti-noise audio signal from the acoustic leakage estimate.

Estimating an external sound audibility based at least partially on the at least one external audio signal and at least one of: the internal audio signal; and the estimate an at least one internal audio signal may comprise: determining an acoustic leakage estimate based on the at least one external audio signal and a function defining the relationship between the at least one external signal to an effective listening signal for a user; generating an anti-noise audio signal based on the at least one external audio signal; and generating the at least one external sound audibility based on subtracting the anti-noise audio signal from the acoustic leakage estimate and the at least one of: the internal audio signal; and the estimate an at least one internal audio signal.

Generating at least one visualization based on the estimated external sound audibility, such that the visualization provides an indication of the audibility of the external audio source comprises displaying the estimated external sound audibility using at least one of: a colour changing material; at least one light emitting diode; a display element; at least one liquid crystal display element; at least one organic light emitting diode display element; and at least one electrophoretic display element.

The apparatus may comprise one of: a smartphone; a headphone; a vehicle equipped with the at least one external microphone; a helmet equipped with the at least one external microphone; and a personal protection equipment equipped with the at least one external microphone.

According to a second aspect there is provided a method for controlling sound audibility of external audio signals within an apparatus, the method comprising: obtaining at least one input; determining whether the at least one input is provided by a user of the apparatus or some other person; and controlling the sound audibility of the external audio signals for the user based on the at least one input and whether the at least one input provided by the user of the apparatus or the other person.

Controlling the sound audibility of the external audio signals for the user based on the at least one input and whether the at least one input is provided by the user of the apparatus or the other person may comprise at least one of: switching between an automatic noise control and transparency mode following determining a large control input from the user; switching from an automatic noise control to a full transparency mode following determining a down swipe from the user; switching from a full transparency mode to an automatic noise control following determining an up swipe from the user; changing an internal sound volume based on a small control input from the user; switching between an automatic noise control and transparency mode following determining any control input from the other person.

According to a third aspect there is provided an apparatus for visualizing sound audibility of external audio signals, the apparatus comprising at least one processor and at least one memory storing instructions that, when executed by the at least one processor, cause the system at least to perform: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

The apparatus caused to perform obtaining at least one external audio signal may be caused to perform obtaining at least one external microphone audio signal, wherein the at least one external microphone is located on or acoustically coupled to an exterior surface of the apparatus, such that the at least one external microphone audio signal is configured to capture audio external to the apparatus.

The apparatus caused to perform obtaining at least one internal audio signal may be caused to perform obtaining at least one internal microphone audio signal, wherein the at least one internal microphone is located on or acoustically coupled to an interior surface of the apparatus, such that the at least one internal microphone audio signal is configured to capture audio internal to the apparatus.

The apparatus caused to perform obtaining an estimate of at least one internal audio signal may be caused to perform estimating at least one internal audio signal to be output via a transducer within the apparatus, such that the estimate of the at least one internal audio signal is configured to assist in estimating the external sound audibility.

The apparatus caused to perform estimating an external sound audibility based at least partially on the at least one external audio signal and at least one of: the internal audio signal; and the estimate an at least one internal audio signal may be caused to perform: determining an acoustic leakage estimate based on the at least one external audio signal and a function defining the relationship between the at least one external signal to an effective listening signal for a user; generating an anti-noise audio signal based on the at least one external audio signal; and generating the at least one external sound audibility based on subtracting the anti-noise audio signal from the acoustic leakage estimate.

The apparatus caused to perform estimating an external sound audibility based at least partially on the at least one external audio signal and at least one of: the internal audio signal; and the estimate an at least one internal audio signal may be caused to perform: determining an acoustic leakage estimate based on the at least one external audio signal and a function defining the relationship between the at least one external signal to an effective listening signal for a user; generating an anti-noise audio signal based on the at least one external audio signal; and generating the at least one external sound audibility based on subtracting the anti-noise audio signal from the acoustic leakage estimate and the at least one of: the internal audio signal; and the estimate an at least one internal audio signal.

The apparatus caused to perform generating at least one visualization based on the estimated external sound audibility, such that the visualization provides an indication of the audibility of the external audio source may be caused to perform displaying the estimated external sound audibility using at least one of: a colour changing material; at least one light emitting diode; a display element; at least one liquid crystal display element; at least one organic light emitting diode display element; and at least one electrophoretic display element.

The apparatus may comprise one of: a smartphone; a headphone; a vehicle equipped with the at least one external microphone; a helmet equipped with the at least one external microphone; and a personal protection equipment equipped with the at least one external microphone.

According to a fourth aspect there is provided an apparatus for controlling sound audibility of external audio signals, the apparatus comprising at least one processor and at least one memory storing instructions that, when executed by the at least one processor, cause the system at least to perform: obtaining at least one input; determining whether the at least one input is provided by a user of the apparatus or some other person; and controlling the sound audibility of the external audio signals for the user based on the at least one input and whether the at least one input provided by the user of the apparatus or the other person.

The apparatus caused to perform controlling the sound audibility of the external audio signals for the user based on the at least one input and whether the at least one input is provided by the user of the apparatus or the other person may be caused to perform at least one of: switching between an automatic noise control and transparency mode following determining a large control input from the user; switching from an automatic noise control to a full transparency mode following determining a down swipe from the user; switching from a full transparency mode to an automatic noise control following determining an up swipe from the user; changing an internal sound volume based on a small control input from the user; switching between an automatic noise control and transparency mode following determining any control input from the other person.

According to a fifth aspect there is provided an apparatus for visualizing sound audibility of external audio signals, the apparatus comprising means configured to: obtain at least one external audio signal; obtain at least one of: an internal audio signal; and an estimate of at least one internal audio signal; estimate an external sound audibility based at least partially on the at least one external audio signal and at least one of: the internal audio signal; and the estimate an at least one internal audio signal; and generate at least one visualization based on the estimated external sound audibility, such that the visualization provides an indication of audibility of an external audio source.

The means configured to obtain at least one external audio signal may be configured to obtain at least one external microphone audio signal, wherein the at least one external microphone is located on or acoustically coupled to an exterior surface of an apparatus, such that the at least one external microphone audio signal is configured to capture audio external to the apparatus.

The means configured to obtain at least one internal audio signal may be configured obtain at least one internal microphone audio signal, wherein the at least one internal microphone is located on or acoustically coupled to an interior surface of an apparatus, such that the at least one internal microphone audio signal is configured to capture audio internal to the apparatus.

The means configured to obtain an estimate of at least one internal audio signal may be configured to estimate at least one internal audio signal to be output via a transducer within the apparatus, such that the estimate of the at least one internal audio signal is configured to assist in estimating the external sound audibility.

The means configured to estimate an external sound audibility based at least partially on the at least one external audio signal and at least one of: the internal audio signal; and the estimate an at least one internal audio signal may be configured to: determine an acoustic leakage estimate based on the at least one external audio signal and a function defining the relationship between the at least one external signal to an effective listening signal for a user; generating an anti-noise audio signal based on the at least one external audio signal; and generate the at least one external sound audibility based on subtracting the anti-noise audio signal from the acoustic leakage estimate.

The means configured to estimate an external sound audibility based at least partially on the at least one external audio signal and at least one of: the internal audio signal; and the estimate an at least one internal audio signal may be configured to: determine an acoustic leakage estimate based on the at least one external audio signal and a function defining the relationship between the at least one external signal to an effective listening signal for a user; generate an anti-noise audio signal based on the at least one external audio signal; and generate the at least one external sound audibility based on subtracting the anti-noise audio signal from the acoustic leakage estimate and the at least one of: the internal audio signal; and the estimate an at least one internal audio signal.

The means configured to generate at least one visualization based on the estimated external sound audibility, such that the visualization provides an indication of the audibility of the external audio source may be caused to display the estimated external sound audibility using at least one of: a colour changing material; at least one light emitting diode; a display element; at least one liquid crystal display element; at least one organic light emitting diode display element; and at least one electrophoretic display element.

The apparatus may comprise one of: a smartphone; a headphone; a vehicle equipped with the at least one external microphone; a helmet equipped with the at least one external microphone; and a personal protection equipment equipped with the at least one external microphone.

According to a sixth aspect there is provided an apparatus for controlling sound audibility of external audio signals, the apparatus comprising means configured to: obtain at least one input; determine whether the at least one input is provided by a user of the apparatus or some other person; and control the sound audibility of the external audio signals for the user based on the at least one input and whether the at least one input provided by the user of the apparatus or the other person.

The means configured to control the sound audibility of the external audio signals for the user based on the at least one input and whether the at least one input is provided by the user of the apparatus or the other person may be configured to, at least one of: switch between an automatic noise control and transparency mode following determining a large control input from the user; switch from an automatic noise control to a full transparency mode following determining a down swipe from the user; switch from a full transparency mode to an automatic noise control following determining an up swipe from the user; change an internal sound volume based on a small control input from the user; switch between an automatic noise control and transparency mode following determining any control input from the other person.

According to a seventh aspect there is provided an apparatus for visualizing sound audibility of external audio signals, the apparatus comprising: obtaining circuitry configured to obtain at least one external audio signal; obtaining circuitry configured to obtain at least one of: an internal audio signal; and an estimate of at least one internal audio signal; estimating circuitry configured to estimate an external sound audibility based at least partially on the at least one external audio signal and at least one of: the internal audio signal; and the estimate an at least one internal audio signal; and generating circuitry configured to generate at least one visualization based on the estimated external sound audibility, such that the visualization provides an indication of audibility of an external audio source.

According to an eighth aspect there is provided an apparatus for controlling sound audibility of external audio signals, the apparatus comprising: obtaining circuitry configured to obtain at least one input; determining circuitry configured to determine whether the at least one input is provided by a user of the apparatus or some other person; and controlling circuitry configured to control the sound audibility of the external audio signals for the user based on the at least one input and whether the at least one input provided by the user of the apparatus or the other person.

According to a ninth aspect there is provided a computer program comprising instructions or a computer readable medium comprising instructions for causing an apparatus, for visualizing sound audibility of external audio signals, the apparatus caused to perform at least the following: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

According to a tenth aspect there is provided a computer program comprising instructions [or a computer readable medium comprising instructions] for causing an apparatus, for controlling sound audibility of external audio signals, the apparatus caused to perform at least the following: obtaining at least one input; determining whether the at least one input is provided by a user of the apparatus or some other person; and controlling the sound audibility of the external audio signals for the user based on the at least one input and whether the at least one input provided by the user of the apparatus or the other person.

According to an eleventh aspect there is provided a non-transitory computer readable medium comprising program instructions for causing an apparatus, for visualizing sound audibility of external audio signals, to perform at least the following: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

According to a twelfth aspect there is provided a non-transitory computer readable medium comprising program instructions for causing an apparatus, for controlling sound audibility of external audio, to perform at least the following: obtaining at least one input; determining whether the at least one input is provided by a user of the apparatus or some other person; and controlling the sound audibility of the external audio signals for the user based on the at least one input and whether the at least one input provided by the user of the apparatus or the other person.

According to a thirteenth aspect there is provided an apparatus, for visualizing sound audibility of external audio signals, the apparatus comprising: means for obtaining at least one external audio signal; means for obtaining at least one of: an internal audio signal; and an estimate of at least one internal audio signal; means for estimating an external sound audibility based at least partially on the at least one external audio signal and at least one of: the internal audio signal; and the estimate an at least one internal audio signal; and means for generating at least one visualization based on the estimated external sound audibility, such that the visualization provides an indication of audibility of an external audio source.

According to a fourteenth aspect there is provided an apparatus, for controlling sound audibility of external audio signals, the apparatus comprising: means for obtaining at least one input; means for determining whether the at least one input is provided by a user of the apparatus or some other person; and means for controlling the sound audibility of the external audio signals for the user based on the at least one input and whether the at least one input provided by the user of the apparatus or the other person.

According to a fifteenth aspect there is provided a computer readable medium comprising instructions for causing an apparatus, for visualizing sound audibility of external audio signals, to perform at least the following: obtaining at least one external audio signal; obtaining at least one of: an internal audio signal; and an estimate of at least one internal audio signal; estimating an external sound audibility based at least partially on the at least one external audio signal and at least one of: the internal audio signal; and the estimate an at least one internal audio signal; and generating at least one visualization based on the estimated external sound audibility, such that the visualization provides an indication of audibility of an external audio source.

According to a sixteenth aspect there is provided a computer readable medium comprising instructions for causing an apparatus, for controlling sound audibility of external audio signals, to perform at least the following: obtaining at least one input; determining whether the at least one input is provided by a user of the apparatus or some other person; and controlling the sound audibility of the external audio signals for the user based on the at least one input and whether the at least one input provided by the user of the apparatus or the other person.

An apparatus comprising means for performing the actions of the method as described above.

An apparatus configured to perform the actions of the method as described above.

A computer program comprising instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIGS. 1a and 1b show example apparatus with lights suitable for implementing some embodiments;

FIGS. 2a to 2e show example apparatus and light patterns illustrating different external and internal sound conditions according to some embodiments;

FIG. 3 shows an example apparatus suitable for determining audibility estimates (estimating leakage) in an external microphone only configuration according to some embodiments;

FIG. 4 shows a flow diagram of the operation of the example apparatus suitable for determining audibility estimates (estimating leakage) as shown in FIG. 3 and providing a visualization of the estimates according to some embodiments;

FIG. 5 shows an example apparatus for providing visualization of audibility estimates (estimating leakage) in some embodiments;

FIG. 6 shows a further example apparatus suitable for determining audibility estimates (estimating leakage) in an external microphone only configuration according to some embodiments;

FIG. 7 shows a further example apparatus suitable for determining audibility estimates (estimating leakage) in an internal microphone configuration according to some embodiments;

FIG. 8 shows a flow diagram of the operation of the example apparatus suitable for determining audibility estimates (estimating leakage) as shown in FIG. 7 according to some embodiments;

FIG. 9 shows an example apparatus with user interface inputs suitable for implementing some embodiments; and

FIG. 10 shows schematically an example apparatus suitable for implementing some embodiments.

### EMBODIMENTS OF THE APPLICATION

The embodiments as discussed herein aim to assist the visualization of audibility for a user for example within a vehicle, wearing a helmet or personal protective equipment (PPE), or wearing headphones, earbuds or some head mounted audio transducer system. In the following embodiments the apparatus are equipped with an active noise cancellation (ANC) system. However it would be appreciated that in some embodiments the apparatus are equipped with passive noise cancelling or noise blocking systems and the examples as described herein would be similarly applicable.

As discussed above determining and indicating the attentiveness of the user or in other words the ‘external’ or local audio source sound audibility is a topic of research. There are several reasons why this research is being pursued.

Upcoming Immersive Voice and Audio Services (IVAS) standard and Immersive Voice applications are configured to provide immersive audio communications. This type of communication system is more immersive meaning that users' cognitive abilities will be more immersed to the communication than before.

In addition to the above scenarios and with respect to headphones, taking headphones off and placing headphones back on is tiresome. Furthermore, earbuds which are placed in the ear and held by friction when inserted and removed often can rub the ear and lead to poor fitting, especially when memory foam starts to lose resilience following a certain number of insertions.

Thus, typically a user will leave headphones on or earbuds in the ear even when not actively listening to an internal source or listening and/or talking to someone else. As discussed above typically the headphones can be equipped with a pass though mode which can be selected and presents the external audio signals to the headphone user without any cancellation.

This can annoy other people when attempting to connect or attract the attention of the user of the headphones. For example, a person attempting to talk to the user wearing headphones can consider not removing the headphones to be an anti-social or rude action as the talker cannot determine whether the user wearing the headphones can hear them.

It is not straightforward to estimate whether a headphone user can hear external sound sources or in other words determine an audibility estimate for external audio signals. For example, headphones that don't have an inner microphone do not have direct means to enable the estimation of audibility.

Furthermore, audibility can be affected by many factors and these can exacerbate the problem of estimating what headphone wearing users can hear. For example, audibility estimation should incorporate factors such as the level of internal sounds, headphone fit that affects acoustical leakage and headphone playback.

Additionally, even when audibility can be estimated and visualised the ability to alter the audibility, for example conventional methods for controlling ANC/transparency and internal sound level can be cumbersome because they typically require the use of at least two separate controls. Thus, a talker (or the user of the headphones) cannot easily change the audibility which may be required in an emergency situation.

This issue can similarly occur in the scenarios also presented above. For example rather than attempting to get a headphone wearing user's attention a talker may be attempting to get a car driver's attention (for example to request identification when passing through a security checkpoint) or a motorcycle rider (for example to indicate that the helmet is to be removed), a wearer of PPE (for example to direct the person wearing the PPE where their vision is restricted by the PPE).

Thus, the aim of the embodiments as discussed in further detail is the provision of apparatus and methods for estimating audibility, and for example how much a headphone user hears external sounds with respect to all sounds (external+internal) while wearing the headphones and indicating this to others.

Furthermore is provided in some embodiments a simple or single control interface which can be configured to enable the audibility to be changed, for example to control both the ANC/transparency amount and internal sound level at the same time.

These apparatus and methods can be employed in IVAS standard and Immersive Voice based immersive audio communications. The embodiments are particularly applicable to this type of communication as they are immersive, meaning that a user's cognitive abilities will be more immersed within the communication than with a conventional audio communications call. The user in an immersive audio communications call may not always pay as much attention to their surroundings and therefore visualising the audibility and therefore indicating a ‘level of attention’ based on the estimation of the audibility based on the external and internal audio signal components enables others to identify whether they can be heard.

The concept as will be discussed in further detail in the embodiments hereafter can be, with respect to a first aspect, methods and apparatus which provides an estimation of external sound audibility and is able to display the estimated external sound audibility in a suitable manner. The external sound audibility can for example be represented as an external sound audibility associated with headphones that do not comprise an inner microphone (or in other words only comprises external microphones). However external sound audibility can refer more generally to the ability of a user to hear a further person, where the parties are at least partially acoustically separated or disconnected. For example, the user can be within a vehicle, or wearing a helmet or other personal protective equipment (PPE). Thus, the ability of the user to hear the talker when wearing the helmet (or within the vehicle) is able to be displayed to the talker.

The following examples will focus on the concept when applied to the estimation of external sound audibility when the user is wearing headphones with the means for estimating the external sound audibility and the means for displaying the estimated external sound audibility being implemented within the headphones. However, it would be appreciated that the following can be applied to other scenarios, such as the wearing of a helmet or PPE or within a vehicle with the means for estimation and displaying being implemented within these apparatus or apparatus associated with these apparatus. For example in the case of the user wearing PPE, the PPE can be equipped with external microphones and internal transducers but also connected (for example wirelessly) to a mobile device which provides the means for estimation and possibly also the means for displaying the estimation.

In such embodiments the apparatus is configured to employ at least the active noise cancellation (ANC) signal of the headphones at low frequencies (because that signal is already available) as the starting point for generating an estimate of external sound audibility.

In some embodiments this estimate of external sound audibility can be displayed or visualized for other people to see whether the (headphone) user can (or is likely to) hear them.

Furthermore, in some embodiments, an estimate for external sound audibility (for a headphone user) can be determined based on the internal sound (from an inner microphone) but does not directly visualize the internal sound level to keep the internal sound private. However, in such embodiments the external sound audibility is estimated and the visualization of the external sound availability is provided to other people.

In some further embodiments there is provided apparatus and methods configured to control both ANC/transparency and internal sound level with a single or simple volume control button/slider. In some embodiments the control mechanism aims to keep internal sound level as low as possible by using ANC/transparency as much as possible to attenuate external sounds. In some further embodiments, instead of increasing internal sound volume, the ANC functionality is increased (or placed on a higher setting). In these embodiments the internal sound is controlled to sound louder, because external noises are attenuated by the ANC. The ANC/transparency control is, in these examples, used more for replacing a volume control the louder the bass frequencies are in the external sounds because ANC/transparency control effect is at its most clear when there is a lot of bass in the external sounds. In this way user hearing is protected and user can hear external sound sources better.

The simple or single (volume) control button/slider can in some embodiments be configured such that a large swipe from a headphone user can cause both the internal sound level to go down/up and to control an ANC switch to alternate between transparency mode/ANC mode respectively. Additionally, in some examples a small swipe by the headphone user causes only an internal sound level change.

Furthermore, in some examples if someone other than the headphone user swipes the volume control, then ANC is configured to (always) change to transparency mode. In this way the other person can quickly get the attention of the headphone user and the other person can be heard.

The visualizations can be light colours, light brightness, light flashing patterns or more complex image based or message based visualizations. The visualization can be represented by a single light (or light emitting diode) or more than one light or an array of lights (or light emitting diodes). In some embodiments the visualization can be any suitable display technology, such as LCD, OLED, or electrophoretic display. In some embodiments the visualizations can be implemented by colour changing materials, where the colour of the product (for example headphones, smartphone, vehicle etc) changes either partially or entirely. For example a PPE helmet could comprise at least a strip of colour changing material which is configured to change colour based on whether the wearer is able to hear the external talker.

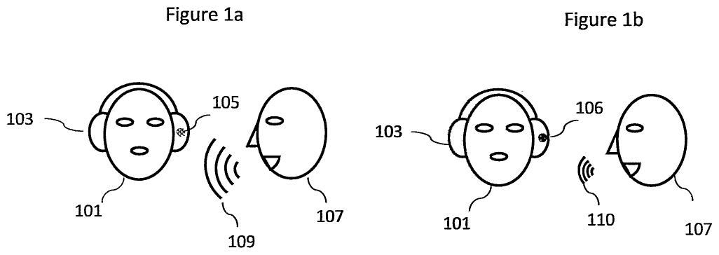

Example potential visualizations which can be displayed by the headphones is shown in FIG. 1a and FIG. 1b.

FIG. 1a for example shows a user 101 wearing a set of headphones 103 and a further person 107 talking with a ‘loud’ voice 109. The headphones 103 can comprise a LED (light emitting diode) or other light source which outputs a first visualization 105 (which can based on the example embodiment be a light pattern, colour, brightness, image or message) configured to indicate that the user 101 is able to hear the further person 107. In other words, a first visualization 105 indicating that the headphones have a ‘good’ audibility of the further person 107. In this example the visualization is a first colour, for example but not shown the visualization is a green light.

Furthermore, FIG. 1b shows the same user 101 and headphones 103 and the further person 107 talking with a ‘quiet’ voice 110. The LED or other light source is configured to output a second visualization 106 configured to indicate that the user 101 is not able to hear the further person 107. In other words, a second visualization 106 indicates that the headphones have a ‘poor’ audibility. In this example the visualization is a second colour, for example but not shown the visualization is a red light.

Although the examples shown in FIG. 1a and FIG. 1b show whether the user is able to hear the further person (or an external source talker) or indicating a good/poor audibility, the visualization does not reflect the internal and external sound conditions.

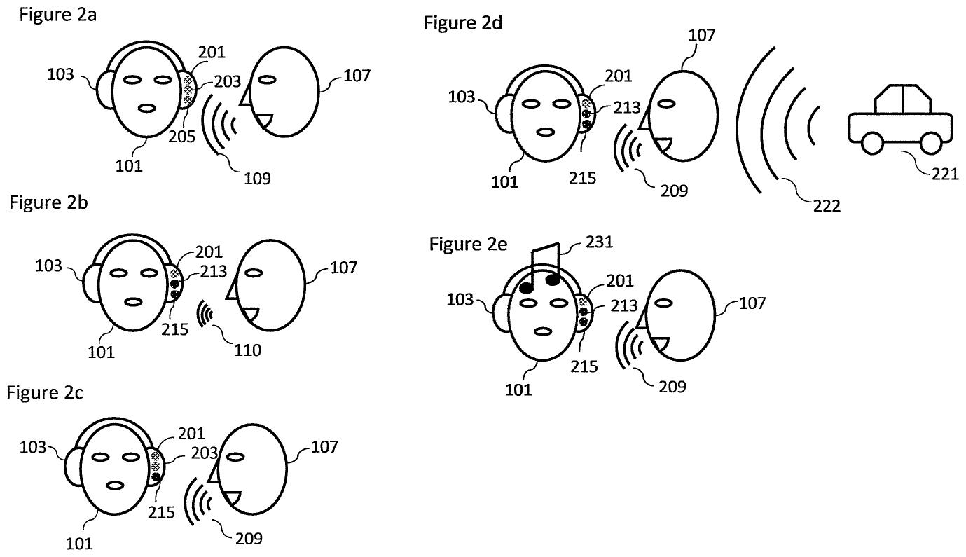

An example further visualization of audibility based on internal and external sound conditions is shown with respect to FIGS. 2a to 2e.

FIG. 2a for example shows the user 101 wearing the set of headphones 103 and the further person 107 is talking with a ‘loud’ voice 109. In this example the visualization or display means comprises a series of LED or other light sources which output a first visualization configured to indicate a ‘good’ audibility based on both internal and external sound conditions and that the user 101 is able to hear the further person 107. In this example the visualization is shown by three LEDs comprising a top, middle and bottom LED. In this ‘good’ audibility or sound condition example the LEDs all show a first colour, green top LED 201, green middle LED 203, and green bottom LED 205. The choice of colour or arrangement of LEDs in this and further examples can change based on the application providing that the visualization is consistent.

FIG. 2b shows a situation where the further person 107 is talking with a ‘quiet’ voice 110 and therefore is a ‘poor’ audibility or sound condition example. In this example the visualization is configured to indicate that the user 101 is not able to hear the low volume level talker. In this example the ‘poor’ audibility or sound condition example has a visualisation employing the LEDs in such a way that there is a first colour for the top LED, green top LED 201, but a second colour for the middle and bottom LED, a red middle LED 213, and red bottom LED 215.

FIG. 2c shows a situation where the further person 107 is talking with a ‘adequate’ volume voice 209 and therefore in this example where there is no external noise or interfering audio sources or internal audio source there is an ‘adequate’ audibility or sound condition example. In this example, the visualization is configured to indicate that the user 101 is (just) able to hear the talker. In this example the ‘adequate’ audibility or sound condition example has a visualisation employing the LEDs in such a way that there is a first colour for the top and middle LED, green top LED 201, green middle led 203 but a second colour for the bottom LED, a red bottom LED 215.

FIG. 2d shows a situation where the further person 107 is talking with the ‘adequate’ volume voice 209 but there is also an external audio source 221 which generates noise or interference audio signals 222 which results in a ‘poor’ audibility or sound condition example. In this example the visualization is configured to indicate that the user 101 is not able to hear the ‘adequate’ volume level talker because of the external audio source. In this example the ‘poor’ audibility or sound condition example has a visualisation employing the LEDs in such a way that there is a first colour for the top LED, green top LED 201, but a second colour for the middle and bottom LED, a red middle LED 213, and red bottom LED 215.

FIG. 2e shows a situation where the further person 107 is talking with the ‘adequate’ volume voice 209 but there is also an internal audio source 231 (music input) which effectively decreases the sound condition and results in a ‘poor’ audibility or sound condition example. In this example the visualization is configured to indicate that the user 101 is not able to hear the ‘adequate’ volume level talker because of the internal audio source. In this example the ‘poor’ audibility or sound condition example has a visualisation employing the LEDs in such a way that there is a first colour for the top LED, green top LED 201, but a second colour for the middle and bottom LED, a red middle LED 213, and red bottom LED 215.

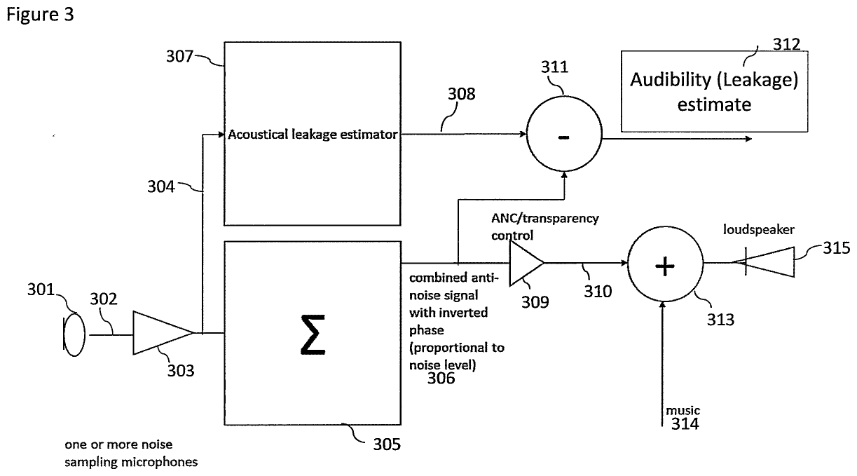

With respect to FIG. 3 a schematic view of an example apparatus suitable for implementing some embodiments is shown. ANC based headphones can be configured without an inner microphone (the inner microphone being a microphone between speaker and eardrum). This configuration can be implemented for cost saving but also can be implemented in situation for weight and/or package size reduction. Thus, cheaper and/or smaller headphones can be designed in this manner as they would not be able to be equipped with a big enough battery and/or the computation power to use a large number of microphones.

Headphones with an inner microphone can be implemented where the observation and estimation can be performed from the inner microphone recorded signal.

In the example shown in FIG. 3 the apparatus and the ANC feature in the headphones (without inner microphones) comprises at least one external microphone 301 (which can be implemented as a microphone on the external surface of the headphone or with an acoustic opening on the external surface of the headphone). The implementation, such as shown in FIGS. 3, can employ a feed-forward ANC.

In the embodiment shown in FIG. 3 the at least one external microphone 301 generates captured audio 302 which is passed to a microphone gain (or microphone amplifier) 303, the output 304 of the microphone amplifier 303 passed to an acoustical leakage estimator 307 and a combiner 305.

The combiner 305 is configured to output a combined anti-noise signal with an inverted phase (and is proportional to the noise level) 306 which is passed to an ANC/transparency controller 309 and the audibility (leakage) estimator negative combiner 311.

The acoustical leakage estimator 307 is configured to receive the signal 304 from the output of the microphone amplifier 303 and generates an acoustical leakage estimate 308 which is also passed to the audibility (leakage) estimator negative combiner 311.

The audibility (leakage) estimator negative combiner 311 receives the acoustical leakage estimate 308 and combined anti-noise signal 306 and generates the audibility (leakage) estimate 312.

The ANC/transparency control 309 furthermore is configured to receive the combined anti-noise signal 306 and output an ANC/transparency signal 310 which is passed to a combiner 313. The level of the anti-noise signal 306 can be controlled (by a user) in the ANC/transparency control 309. For example, when ANC is desired, the combined anti-noise signal 306 is fed to the loudspeaker as such and when transparency is desired, the combined anti-noise signal 306 is reduced or zeroed altogether.

The combiner 313 is further configured to receive the music (or internal audio source) audio signal 314 and output a combined audio signal to the transducer (or loudspeaker) of the headphones 315.

In other words, the apparatus is configured to receive as an input at least one externally mounted or coupled microphone audio signal and estimate an anti-noise signal from the microphone audio signal from it (based on any suitable method). At its simplest the anti-noise signal 306 is just the external microphone signal 304 inverted and low-pass filtered.

Typically, the ANC/transparency control 309 can also be configured to also feed the microphone signal directly into the loudspeaker when transparency is desired (not shown in this FIG. 3).

ANC typically is implemented only in lower frequencies because the headphone (passively) mechanically attenuates higher frequencies well. Furthermore, at lower frequencies the delay in the anti-noise signal creation and playback is not as critical. At lower frequencies a small delay is acceptable because the phase changes slowly and a slightly delayed anti-noise signal still functions as a good noise cancelling audio signal.

The acoustical leakage estimator 307 in some embodiments therefore receives an outer or external microphone audio signal and applies a transfer function to it. The transfer function is configured to mimic the attenuation caused by the mechanical structure of the headphones for external sounds travelling to the user's ear.

In some embodiments the transfer function is a frequency dependent attenuation that is configured to attenuate the microphone signal by close to 0 dB at lower frequencies (e.g. below 50 Hz) and attenuates increasingly more at higher frequencies (e.g. 10 dB at 5 kHz).

A simulation of the effect of the application of ANC effect to the sounds that the user can hear can be formed by subtracting the ANC anti-noise signal 306 from the acoustic leakage estimation 308 (such as shown by the audibility estimator negative combiner 311). In some embodiments if the transparency mode is used or enabled, then the anti-noise signal switches to a signal that amplifies sounds, but the same subtraction is also implemented in this case.

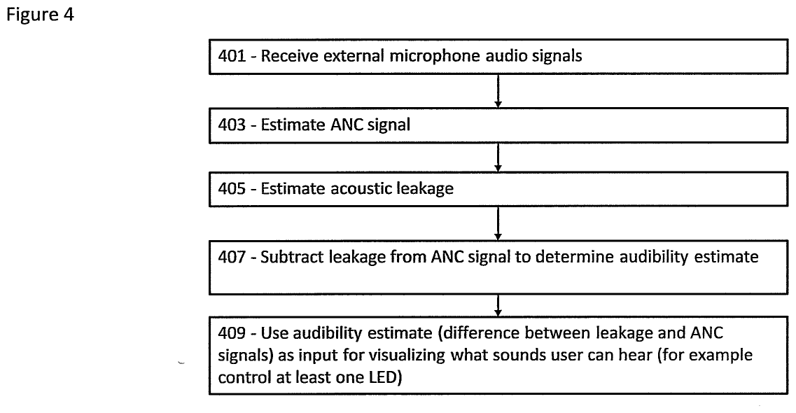

With respect to FIG. 4 is shown an example flow diagram showing the operations of the apparatus shown in FIG. 3.

Thus is shown a first operation of receiving external microphone audio signals as shown in FIG. 4 by step 401.

Then is shown the operation of estimating the ANC signal from the external microphone audio signals as shown in FIG. 4 by step 403.

Furthermore is shown in FIG. 4 the operation of estimating the acoustic leakage from the external microphone audio signals as shown in FIG. 4 by step 405.

Having determined the ANC and the acoustic leakage audio signals, then an audibility estimate or sound condition estimate can be determined based on a difference between the ANC and the acoustic leakage audio signals as shown in FIG. 4 by step 407.

Then the audibility estimate or sound condition estimate can be used as the input for generating a visualisation to indicate what sounds a user can hear as shown in FIG. 4 by step 409.

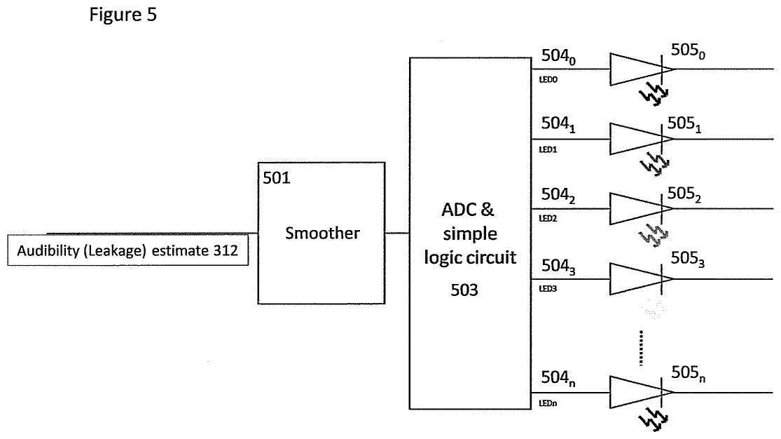

With respect to FIG. 5 is an example apparatus for generating visualisations from the audibility (leakage) estimate 312.

In this example the apparatus comprises a smoother 501 configured to receive the audibility (leakage) estimate 312 and generate a smoothed version to be passed to an analogue to digital converter (ADC) and logic circuit 503. The smoothing can be any suitable smoothing, for example, a low pass filtering of the estimate values. In some embodiments the smoothing is implemented on a frequency band-by-band basis and the band values are combined after weighting with a weighting function.

The ADC and logic circuit 503 is configured to receive the smoothed values and control at least one LED based on the averaged values. For example, the audibility (leakage) estimation can be used for example to illustrate to other users if the headphone user can hear them.

Thus, for example, an array of LEDs 505₀ to 505ₙ are shown which are controlled or driven by ADC and logic circuit outputs 504₀ to 504ₙ. Thus, the higher the average the more of the LEDs are powered (or switched from red to green).

The LED lights can be used to indicate this as others can see from the lights if their voice causes a visible change to the LED lights. In other words, when the other person is talking the LED lights change, then the other person knows that the headphone user can hear them. If there is no significant change in the LED lights then they know that the headphone user cannot hear them.

In some embodiments the bigger the audibility estimate, the more LED lights are illuminated. Additionally or alternatively, in some embodiments, as discussed about the LED colours can be also used to indicate whether the headphone user can hear others (and typically a green colour can indicate that the headphone user can hear others).

In some embodiments the LED or visualization and the audibility estimate is directed to speech audibility. This can be achieved using any suitable method or apparatus. For example, to employ band-pass filtered signals where the band-pass filter is centred around dominant speech frequencies. In other words, the frequency bands for which the audibility estimate is determined are typically 400 Hz-4 kHz and thus the band pass filter centre frequency is approximately ˜1 kHz. In some embodiments a voice activity detection (VAD) algorithm can be employed to detect when speech is present and to run the audibility estimation for these detected segments then.

In some embodiments speech separation algorithms can be employed to detect the amount of speech and determine the audibility estimate only from that determined amount.

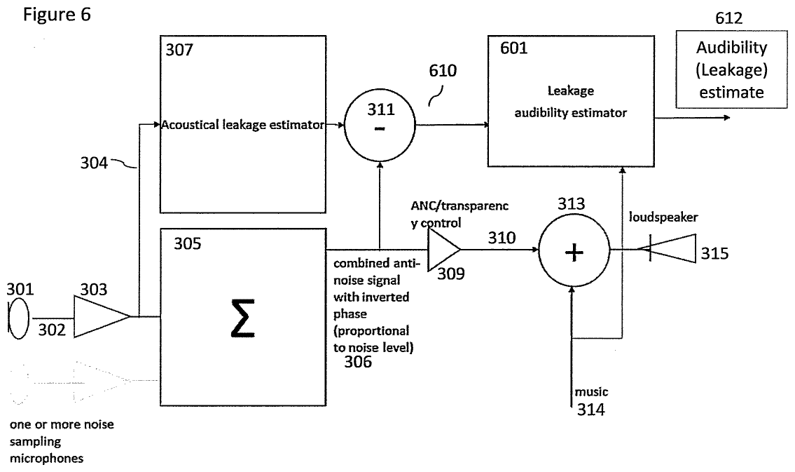

In some embodiments an audibility estimate (based on the leakage) is determined further based on the internal audio signal (the music audio signal 314). For example, FIG. 6 shows an example similar to FIG. 3 but a leakage audibility estimator 601 is configured to receive the output of the audibility (leakage) estimator negative combiner 311 or leaked audio 610 and the music audio signal 314 to generate the audibility (leakage) estimate 612. The leakage audibility estimator 601 is configured to compare the leaked audio 610 to the internal audio signal 314 (music). In some embodiments this comparison is a simple energy ratio ((leaked audio)/(internal audio)), or energy ratio in frequency bands or the leaked audio can be compared to a masking threshold calculated from the internal audio signal.

In some embodiments if the leaked audio is below the masking threshold or for example an energy ratio is below −10 dB, then the leakage audibility estimate is 0. The more the leaked audio is above the threshold or the larger the energy ratio is, the larger is the audibility estimate. In some embodiments the estimate may be scaled and limited so that it reaches maximum value of 1 when leaked audio is 30 dB above masking threshold or energy ratio is above 20 dB.

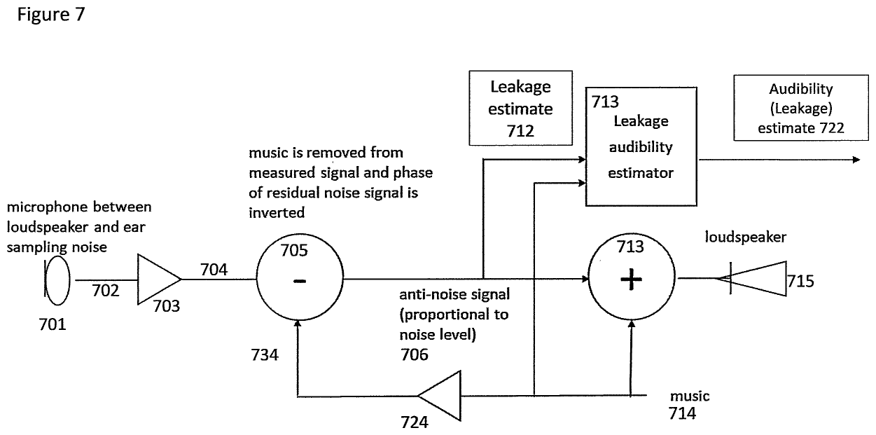

In some embodiments FIG. 7 shows a further example apparatus where an inner microphone is used to generate an audio signal as the basis of the audibility estimate.

In the embodiment shown in FIG. 7 the at least one internal microphone 701 generates captured audio 702 which is passed to a microphone gain (or microphone amplifier) 703, the output 704 of the microphone amplifier 703 passed to a negative combiner 705.

Additionally, the music audio signal 714 (or internal source) is passed to music amplifier 724 which outputs an amplified music audio signal 734 also to the negative combiner 705.

The negative combiner 705 generates a combined anti-noise signal with an inverted phase (and is proportional to the noise level) 706 which is passed to a combiner 713 and passed to the leakage audibility estimator 713 as a leakage estimate 712.

The combiner 713 is configured to receive the music (or internal audio source) audio signal 714 and combined anti-noise signal 706 and output a combined audio signal to the transducer (or loudspeaker) of the headphones 715.

The leakage audibility estimator 713 is configured to receive the music (or internal audio source) audio signal 714 and combined anti-noise signal (as the leakage estimate 712) and output the audibility (leakage) estimate 722 which is used to generate the visualization.

The audibility (leakage) estimate can in some embodiments be used to control LEDs in a manner similar to that described above.

In these embodiments the energy changes in the internal sounds that the headphone user is listening to is hidden from other persons. This therefore improves the privacy of the user of the headphones.

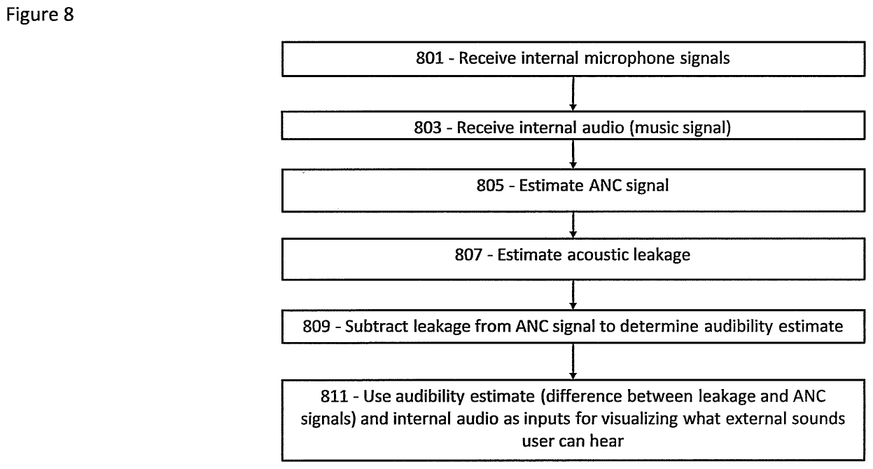

With respect to FIG. 8 is shown an example flow diagram showing the operations of the apparatus shown in FIG. 7.

Thus is shown a first operation of receiving (internal) microphone audio signals as shown in FIG. 8 by step 801.

Also is shown an operation of receiving internal audio signals (such as music audio signals) as shown in FIG. 8 by step 803.

Then is shown the operation of estimating the ANC signal from the external microphone audio signals as shown in FIG. 8 by step 805.

Furthermore is shown in FIG. 8 the operation of estimating the acoustic leakage from the internal microphone audio signals as shown in FIG. 8 by step 807.

Having determined the ANC and the acoustic leakage audio signals, then an audibility estimate or sound condition estimate can be determined based on a difference between the ANC and the acoustic leakage audio signals as shown in FIG. 8 by step 809.

Then the audibility estimate or sound condition estimate can be used as the input for generating a visualisation to indicate what sounds a user can hear as shown in FIG. 8 by step 811.

The user of the headphones could suffer from hearing damage over time when the headphones are set to too high a level. The most common reason for increasing music volume is that external noises sources or interfering external sources make hearing internal audio signals (for example music audio signals) difficult. Therefore, a headphone user's hearing can be protected by increasing ANC instead of internal sound (music) level when user presses/swipes sound level control. This can also be more practical than using two different controls as is implemented in known headphones.

As is always the case, when a user controls something, there has to be a tangible result, otherwise a user will believe that the headphones or device is broken. Therefore, using ANC to replace music level control should only be employed in noisy surroundings. In quiet surroundings there is no noise for the ANC to cancel and therefore any changes in ANC operation are mostly not noticeable. Also, the effect of the application of ANC is often biggest at lower frequencies for beforementioned reasons. In higher frequencies the effect comes from transparency mode where external sounds are fed into headphone transducer or device speaker using an outer or external microphone.

Thus, in some embodiments a control for simultaneously affecting both ANC and transparency is employed. When transparency mode is at full setting, then typically ANC is mostly off and in higher frequencies the attenuating effect (higher passive attenuation at higher frequencies) of the headphone body is compensated by feeding external sounds to the speaker. When transparency is at a lower setting, then ANC is used to attenuate low frequencies and at higher frequencies the device relies mostly on the passive attenuation of the device body.

In some embodiments the ‘volume’ change control is therefore configured to implement the following actions based on whether background noise is determined to be present or not.

| | Background noise present | No background noise |
|---|---|---|
| User increases | First, ANC is increased | Internal volume is |
| volume | to a higher setting and | increased |
| | transparency is reduced | |
| | and only when these have | |
| | reached limits, internal | |
| | volume is increased | |
| User decreases | If volume is at a high | Internal volume is |
| volume | setting then internal | decreased |
| | volume is decreased. If | |
| | volume is already at a | |
| | low setting, then internal | |
| | volume is decreased and | |
| | ANC is decreased and | |
| | transparency is increased. | |

In some embodiments the control is configured to provide different combinations and steps. The aim of such embodiments is to keep the music volume down as much as possible without sacrificing user experience of there being a clear change in audio with every volume button press and in addition using transparency mode at lower volume settings so that user can hear their surroundings.

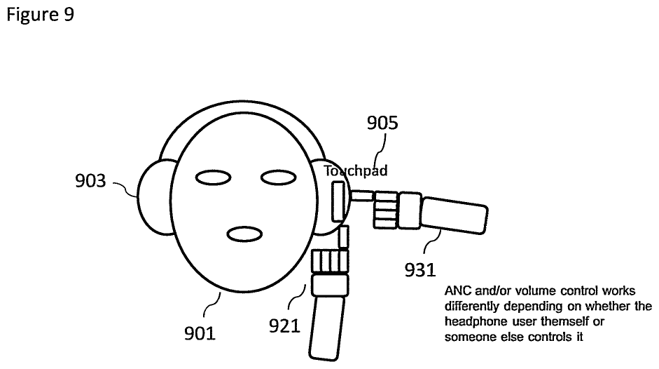

A suitable input could for example be that as shown in FIG. 9. In this example a user 901 is wearing headphones 903 which comprise a touchpad 905 which can be interacted with by the hand/finger 921 of the user 901.

However, in some embodiments the user controller (for example the touchpad 905) is configured to provides additional UI controls for a single button/switch/touchpad that controls ANC/transparency and internal audio volume functions when a further user (as shown by hand 931) attempts to interact with it.

Thus, in some embodiments, the user controller is configured to detect or determine a large control input. The large control input can for example be a swipe. For example, a swipe “down” configured to automatically change the ANC/transparency from ANC to full transparency if full transparency wasn't already being used. Similarly, a large control input or swipe “up” can be configured to change transparency to ANC.

These large controls would be where the headphone user wants a significant change in the audio levels and this typically means that user wants to hear their surroundings or wants to not hear their surroundings. A large control can be detected from a touchpad or volume control input which is significant, for example a swipe more than 50% of the total length of a touchpad or pressing a volume control input for more than 1 second.

In addition to controlling the ANC/transparency mode, the control may change internal sound volume.

In some embodiments, the apparatus is configured to detect where the control was given by the headphone user or somebody else. If the input is provided from the headphone user, then the effects as discussed previously can be applied. In some embodiments there the apparatus determines that the control was provided by another user, then the headphones are configured to switch to a transparency or pass-through mode if the control input from someone else was a “down” input and to switch on ANC if the control input from someone else was an “up” input.

In addition, the control can be configured to control the internal sound volume. As the other person is typically not interested in the headphone user's internal sound level, but only in whether the headphone user can hear them. Thus, such a control makes sense when implemented.

In some embodiments the apparatus can be configured to distinguishing between the control provided from the headphone user and somebody else using any suitable method. For example, in some embodiments where the control is implemented in a mobile phone, the phone camera can be used to recognize if the person providing the control is wearing the headphones. In some embodiments wireless localization techniques such as BT LE can be employed to localize the direction of the headphones and whether the direction is in front of the phone, then it is the headphone user providing the control on the phone and otherwise it is somebody else.

In some embodiments the controller identification can be based on fingerprint recognition. In addition, in the case of recognizing who have the control command, a voice control interface can be used. A user can be recognized using known user voice recognition methods and the ANC control behaves as above based on recognized user.

Furthermore, in some embodiments, a device B belonging to the other person (user B) can be used by user B to control the audibility of user B for the headphone user (user A) wearing headphones (device A). If user B brings device B in the proximity of device A or points device B towards device A, device B may indicate that it is synced with device A by giving feedback. User B may then use device B to control device A ANC. A proximity can be detected using any suitable manner, for example proximity detection can be based on GPS, a camera that detects device A or other positioning methods. A pointing detection means can be using a Bluetooth LE antenna array that detects the direction of other Bluetooth devices. Feedback may be lights or visualization on a display similar to as described previously, or some haptic or vibration feedback. The control can be touch screen or other touch detecting sensors, voice control or a button or virtual button or switch. The User B device may be a wearable device such as ring, headphones, watch or a mobile phone.

For example, user B points their mobile phone (device B) towards user A wearing headphones (device A), user B mobile displays on a display similar colours as the lights in device A, user B slides their finger over the displayed colours to control the ANC of device A to let user A hear user B voice.

The control may also be wireless control from an external device. For example, a museum may control the headphones it provides to museum visitors in safety or security situations. For example, when a fire alarm or some other urgent announcement needs to reach visitors.

Even though the above examples feature a switching between ANC/transparency modes, it would be understood that typical implementations allow a seamless changing between the two modes with multiple intermediate steps or a stepless change between ‘full’ ANC and ‘full’ transparency.

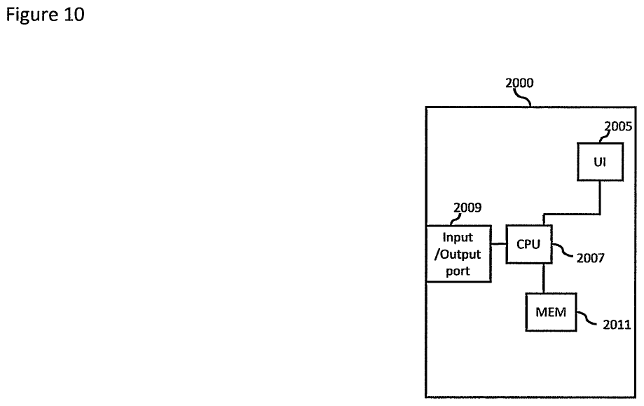

With respect to FIG. 10 an example electronic device which may be used as any of the apparatus parts of the system as described above. The device may be any suitable electronics device or apparatus. For example, in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   I hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for visualizing sound audibility of external audio signals, the method comprising:
obtaining at least one external audio signal;
obtaining at least one of:
an internal audio signal; or
an estimate of at least one internal audio signal;
estimating an external sound audibility based at least partially on the at least one external audio signal and at least one of: the internal audio signal; or the estimate of the at least one internal audio signal; and
generating at least one visualization based on the estimated external sound audibility, such that the visualization provides an indication of audibility of an external audio source.

2. The method as claimed in claim 1, wherein obtaining the at least one external audio signal comprises obtaining at least one external microphone audio signal, wherein the at least one external microphone is located on or acoustically coupled to an exterior surface of an apparatus, such that the at least one external microphone audio signal is configured to capture audio external to the apparatus.

3. The method as claimed in claim 2, wherein obtaining the at least one internal audio signal comprises obtaining at least one internal microphone audio signal, wherein the at least one internal microphone is located on or acoustically coupled to an interior surface of the apparatus, such that the at least one internal microphone audio signal is configured to capture audio internal to the apparatus.

4. The method as claimed in claim 2, wherein obtaining the estimate of the at least one internal audio signal comprises estimating at least one internal audio signal to be output with a transducer within the apparatus, such that the estimate of the at least one internal audio signal is configured to assist in estimating the external sound audibility.

5. The method as claimed in claim 1, wherein estimating the external sound audibility comprises:
determining an acoustic leakage estimate based on the at least one external audio signal and a relationship of the at least one external signal to an effective listening signal for a user;
generating an anti-noise audio signal based on the at least one external audio signal; and
generating the at least one external sound audibility based on subtracting the anti-noise audio signal from the acoustic leakage estimate.

6. The method as claimed in claim 1, wherein estimating the external sound audibility comprises:
determining an acoustic leakage estimate based on the at least one external audio signal and a relationship of the at least one external signal to an effective listening signal for a user;
generating an anti-noise audio signal based on the at least one external audio signal; and
generating the at least one external sound audibility based on subtracting the anti-noise audio signal from the acoustic leakage estimate and the at least one of: the internal audio signal; or the estimate of the at least one internal audio signal.

7. The method as claimed in claim 1, wherein generating the at least one visualization based on the estimated external sound audibility, such that the visualization provides an indication of the audibility of the external audio source comprising displaying the estimated external sound audibility using at least one of:
a colour changing material;
at least one light emitting diode;
a display element;
at least one liquid crystal display element;
at least one organic light emitting diode display element; or
at least one electrophoretic display element.

8. The method as claimed in claim 2, wherein the apparatus comprises one of:
a smartphone;
a headphone;
a vehicle equipped with the at least one external microphone;
a helmet equipped with the at least one external microphone; and
a personal protection equipment equipped with the at least one external microphone.

9. A method for controlling an external sound audibility of at least one external audio signal within an apparatus, the method comprising:
obtaining at least one input;
determining whether the at least one input is provided with a user of the apparatus or an other person; and
controlling the external sound audibility of the at least one external audio signal for the user based on the at least one input and whether the at least one input provided with the user of the apparatus or the other person.

10. The method as claimed in claim 9, wherein controlling the external sound audibility for the user comprises at least one of:
switching between an automatic noise control and transparency mode following determining a large control input from the user;
switching from an automatic noise control to a full transparency mode following determining a down swipe from the user;
switching from a full transparency mode to an automatic noise control following determining an up swipe from the user;
changing an internal sound volume based on a small control input from the user; or
switching between an automatic noise control and transparency mode following determining a control input from the other person.

11. An apparatus for visualizing sound audibility of external audio signals, the apparatus comprising:
at least one processor; and
at least one memory storing instructions that, when executed with the at least one processor, cause the apparatus at least to:
obtain at least one external audio signal;
obtain at least one of:
an internal audio signal; or
an estimate of at least one internal audio signal;
estimate an external sound audibility based at least partially on the at least one external audio signal and at least one of: the internal audio signal; or the estimate of the at least one internal audio signal; and
generate at least one visualization based on the estimated external sound audibility, such that the visualization provides an indication of audibility of an external audio source.

12. The apparatus as claimed in claim 11, wherein the instructions, when executed with the at least one processor, cause the apparatus to obtain at least one external microphone audio signal, wherein the at least one external microphone is located on or acoustically coupled to an exterior surface of the apparatus, such that the at least one external microphone audio signal is configured to capture audio external to the apparatus.

13. The apparatus as claimed in claim 12, wherein the instructions, when executed with the at least one processor, cause the apparatus to obtain at least one internal microphone audio signal, wherein the at least one internal microphone is located on or acoustically coupled to an interior surface of the apparatus, such that the at least one internal microphone audio signal is configured to capture audio internal to the apparatus.

14. The apparatus as claimed in claim 12, wherein the instructions, when executed with the at least one processor, cause the apparatus to estimate at least one internal audio signal to be output with a transducer within the apparatus, such that the estimate of the at least one internal audio signal is configured to assist in estimating the external sound audibility.

15. The apparatus as claimed in claim 11, wherein the instructions, when executed with the at least one processor, cause the apparatus to:
determine an acoustic leakage estimate based on the at least one external audio signal and a relationship of the at least one external signal to an effective listening signal for a user;
generate an anti-noise audio signal based on the at least one external audio signal; and
generate the at least one external sound audibility based on subtracting the anti-noise audio signal from the acoustic leakage estimate.

16. The apparatus as claimed in claim 11, wherein the instructions, when executed with the at least one processor, cause the apparatus to:
determine an acoustic leakage estimate based on the at least one external audio signal and a relationship of the at least one external signal to an effective listening signal for a user;
generate an anti-noise audio signal based on the at least one external audio signal; and
generate the at least one external sound audibility based on subtracting the anti-noise audio signal from the acoustic leakage estimate and the at least one of: the internal audio signal; or the estimate of the at least one internal audio signal.

17. The apparatus as claimed in claim 11, wherein the instructions, when executed with the at least one processor, cause the apparatus to generate at least one visualization based on the estimated external sound audibility, such that the visualization provides an indication of the audibility of the external audio source configured to display the estimated external sound audibility using at least one of:
a colour changing material;
at least one light emitting diode;
a display element;
at least one liquid crystal display element;
at least one organic light emitting diode display element; or
at least one electrophoretic display element.

18. The apparatus as claimed in claim 12, wherein the apparatus comprises one of:
a smartphone;
a headphone;
a vehicle equipped with the at least one external microphone;
a helmet equipped with the at least one external microphone; and
a personal protection equipment equipped with the at least one external microphone.

19. An apparatus for controlling an external sound audibility of at least one external audio signal, the apparatus comprising:
at least one processor; and
at least one memory storing instructions that, when executed with the at least one processor, cause the apparatus at least to:
obtain at least one input;
determine whether the at least one input is provided with a user of the apparatus or an other person; and
control the external sound audibility of the at least one external audio signal for the user based on the at least one input and whether the at least one input provided with the user of the apparatus or the other person.

20. The apparatus as claimed in claim 19, wherein the instructions, when executed with the at least one processor, cause the apparatus to at least one of:
switch between an automatic noise control and transparency mode following determining a large control input from the user;
switch from an automatic noise control to a full transparency mode following determining a down swipe from the user;
switch from a full transparency mode to an automatic noise control following determining an up swipe from the user;
change an internal sound volume based on a small control input from the user; or
switch between an automatic noise control and transparency mode following determining a control input from the other person.
